(19) United States
(12) Patent Application Publication
(10) Pub. No.: US 2006/0138912 A1
(43) Pub. Date: Jun. 29, 2006

(54) Cabinet drawer locking assembly

(76) Inventors: Harry Chen, Taichung Hsien (TW); Lung-Chuan Huang, Taichung Hsien (TW)

Correspondence Address: Connolly Bove Lodge & Hutz LLP, P.O. Box 2207, Wilmington, DE, 19899-2207, US

(21) Appl. No.: 11/021,863

(22) Filed: Dec. 23, 2004

(51) Int. Cl. E05C 9/10

(52) U.S. Cl. 312/217

(57) ABSTRACT

A cabinet drawer locking assembly includes a cabinet body and multiple drawers disposed in cabinet body. Each drawer has a hook backward extending therefrom. A first engaging plate is mounted to a back of the cabinet body and a second engaging plate is slidably mounted between the first engaging plate and the back of the cabinet body. A shifting plate is connected to a top of the second engaging plate. A shaft rotatably extends into the cabinet body and through the shifting plate to reciprocally move the shifting plate and the second engaging plate to make the second engaging plate selectively engaged to the hook of each of the drawers.

### BACKGROUND OF THE INVENTION

1. Field of the Invention

The present invention relates to a locking assembly, and more particularly to a cabinet drawer locking assembly.

2. Description of Related Art

A conventional file or tool cabinet is a substantially rectangular case body with six faces. The case body is formed by several panels defining a space therebetween. Several drawers are horizontally disposed in the space layer by layer for placing documents or tools therein. In order to prevent the documents or tools from being stolen or prevent the drawers from dropping out due to shock or inclination of the ground, the file or tool cabinet is equipped with a locking device for locking the drawers.

In order to lock the respective drawers at one time, a conventional device or such as U.S. Pat. No. 4,966,422 discloses a locking device including an up and down movable latch body disposed on the panels of the case body. Each drawer has a hook section corresponding to a latch hole or a latch section of the latch body. The latch body is drivingly connected with a link. One end of the link extends out of the case body to connect with a rotary mechanism such as a key unit. By means of turning the rotary mechanism, the link is driven to drive the latch body to reciprocally move. Accordingly, the hook section can be latched with the latch hole or latch section to lock the respective drawers at one time.

When locking the drawers, the drawers must be totally pushed into the case body so as to locate the hook section at a position where the hook section is latched with the latch hole or latch section. However, it often takes place that after locking the drawers, a user finds that one or some of the drawers are not totally pushed in and are not locked. Under such circumstance, the user must unlock the drawers and then totally push in the drawers and then again lock the drawers. This makes it inconvenient and troublesome to perform the locking operation for the drawers.

The present invention has arisen to mitigate and/or obviate the disadvantages of the conventional locking device of cabinet drawers.

### SUMMARY OF THE INVENTION

The main objective of the present invention is to provide an improved cabinet drawer locking assembly that provides a convenient operation when some drawers are unlocked.

To achieve the objective, the cabinet drawer locking assembly in accordance with the present invention comprises a cabinet body and multiple drawers disposed in cabinet body. Each drawer has a hook backward extending therefrom. A first engaging plate is mounted to a back of the cabinet body and a second engaging plate is slidably mounted between the first engaging plate and the back of the cabinet body. A shifting plate is connected to a top of the second engaging plate. A shaft rotatably extends into the cabinet body and through the shifting plate to reciprocally move the shifting plate and the second engaging plate to make the second engaging plate selectively engaged to the hook of each of the drawers.

Further benefits and advantages of the present invention will become apparent after a careful reading of the detailed description with appropriate reference to the accompanying drawings.

### BRIEF DESCRIPTION OF THE DRAWINGS

FIG. 1 is a perspective schematic view of a cabinet drawer locking assembly in accordance with the present invention;

FIG. 2 is a perspective view of the locking assembly in FIG. 1;

FIG. 3 is an exploded perspective view of the locking assembly in FIG. 2;

FIG. 4 is a front plan view of the locking assembly of the present invention when being unlocked;

FIG. 5 is a cross-sectional view of the locking assembly in FIG. 4 along line 5-5;

FIG. 6 is a cross-sectional view of the locking assembly in FIG. 4 along line 6-6;

FIG. 7 is a partially enlarged plan view of the locking assembly in FIG. 6;

FIG. 8 is a front plan view of the locking assembly of the present invention when the drawers are totally locked;

FIG. 9 is a cross-section view of the locking assembly in FIG. 8 along line 9-9;

FIG. 10 is a cross-section view of the locking assembly in FIG. 8 along line X-X;

FIG. 11 is a partially enlarged plan view of the locking assembly in FIG. 10;

FIG. 12 is a side plan view of the locking assembly of the present invention when one or some of the drawers being unlocked;

FIG. 13 is a partially enlarged plan view of the locking assembly in FIG. 12;

FIG. 14 is a side plan view of the locking assembly of the present invention in FIG. 12 when the hook of the unlocked drawer upwardly pushes the second engaged plate; and

FIG. 15 is a partially enlarged plan view of the locking assembly in FIG. 14.

### DETAILED DESCRIPTION OF THE INVENTION

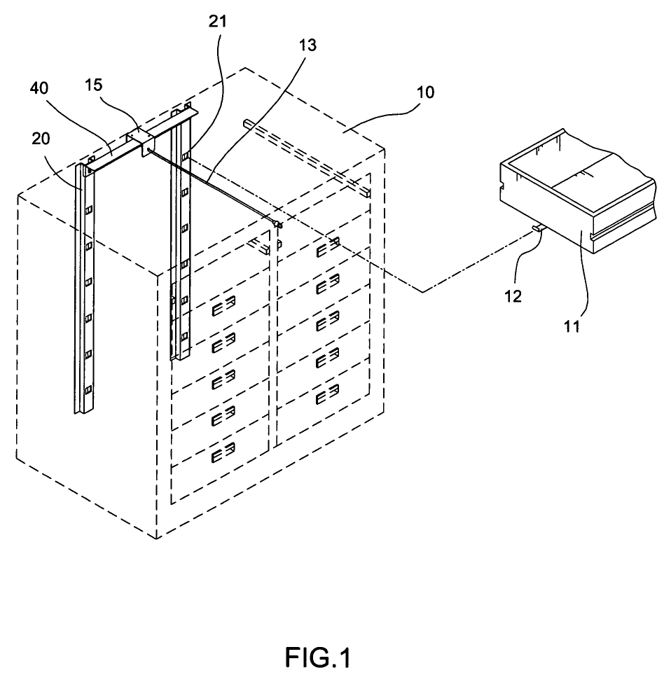

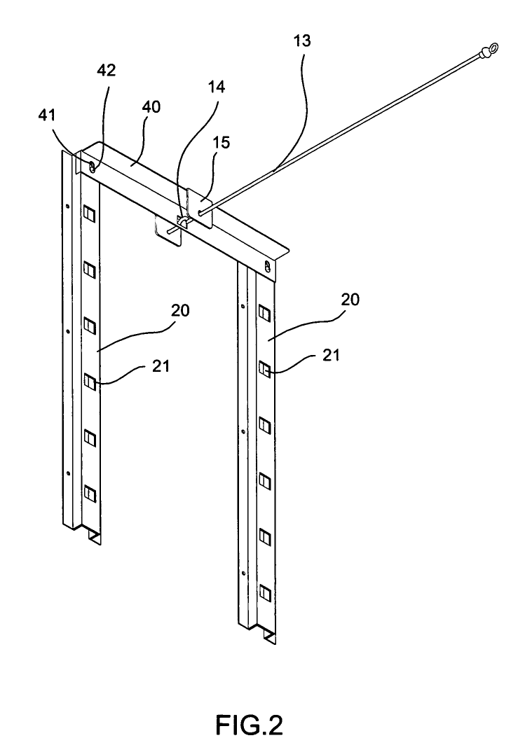

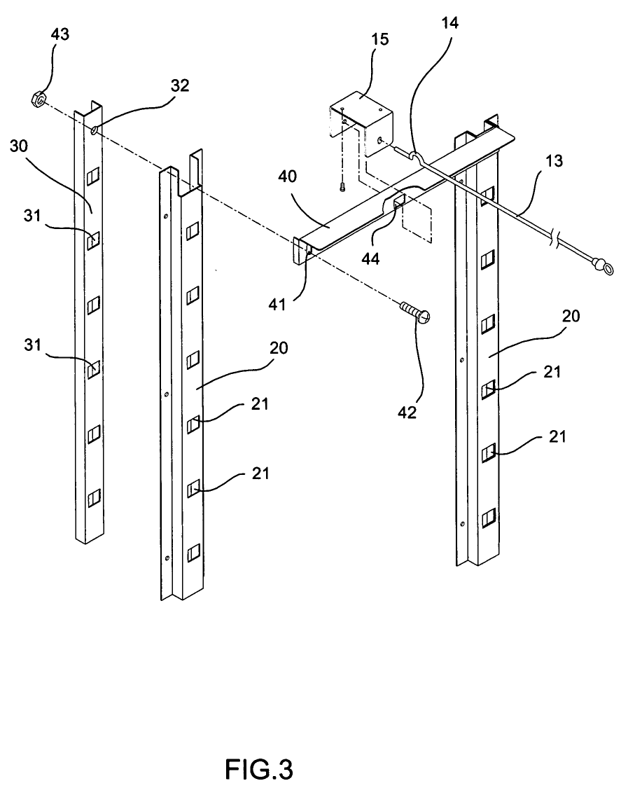

Referring to the drawings and initially to FIGS. 1-5, a cabinet drawer locking assembly in accordance with the present invention comprises a cabinet body (10) and multiple drawers (11) disposed in the cabinet body (10). Each drawers (11) has a hook (12) backward extending therefrom.

A shaft (13) is rotatably mounted on a top portion of the cabinet body (10). The shaft (13) has a first end extending out of the cabinet body (10) and connected with a lock unit (not shown) that controls the shaft (13), and a second end extending through a bracket (15) that is secured on a top of the cabinet body (10).

At least one first engaging plate (20) is vertically secured on a back of the cabinet body (10), and has multiple first engaging holes (21) defined in and extending through the first engaging plate (20). The first engaging plate (20) has an Ω-shaped cross-section such that a passage (not numbered) is formed between the back of the cabinet body (10) and the first engaging plate (20). Each first engaging hole (21) corresponds to a hook (12) of a corresponding one of the multiple drawers (11) to allow the corresponding hook (12) extend through the first engaging plate (20) and entering the passage between the back of the cabinet body (10) and the first engaging plate (20).

At least one second engaging plate (30) is slidably mounted between the first engaging plate (20) and the back of the cabinet body (10) and received in the passage between the back of the cabinet body (10) and the first engaging plate (20). Multiple second engaging holes (31) are defined in and extend through the second engaging plate (30). Each second engaging hole (31) selectively fully communicates with a corresponding one of the multiple first engaging hole (21) to allow the corresponding hook (12) extend through the first engaging plate (20). The second engaging plate (30) has a through hole (32) defined in a top thereof.

A shifting plate (40) laterally extends through the bracket (15). A square hole (44) is defined in the shifting plate (40) to allow the shaft (13) extend through shifting plate (40). The shifting plate (40) is connected to the top of the at least one second engaging plate (30). In the preferred embodiment of the present invention, there are two first and second engaging plates (20, 30), wherein the tops of the two second engaging plates (30) respectively connected to two opposite ends of the shifting plate (40). The shaft (13) has a hump (14) formed thereon and corresponding to a periphery of the square hole (44) in the shifting plate (10) such that the shifting plate (40) is reciprocally up and down moved with the second engaging plate (30) when rotating the shaft (13). The shifting plate (40) has at least one slot (41) defined therein and corresponding to the through hole (32) in the second engaging plate (30) such that the second engaging plate (30) are securely connected to the shifting plate (40) when a screw (42) extends through the through hole (32) and the slot (41), and a nut (43) being screwed onto the screw (42).

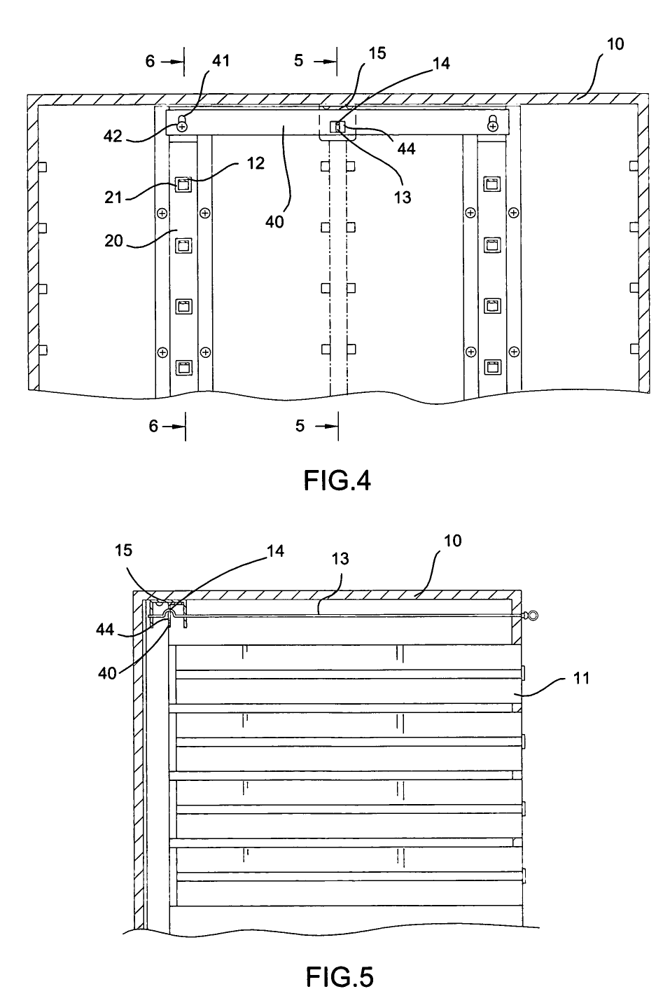

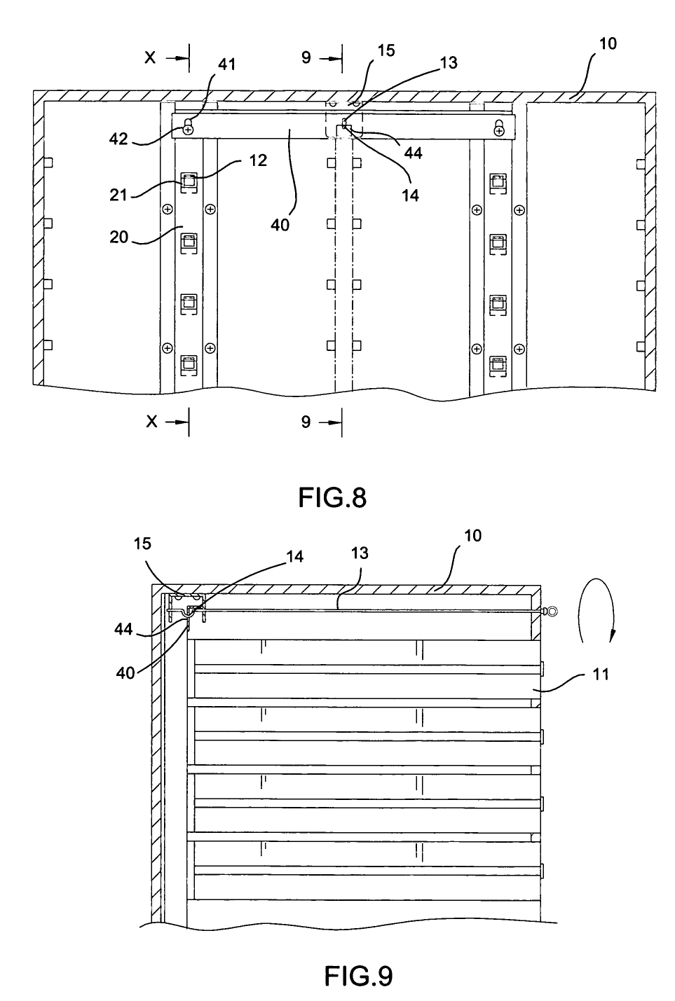

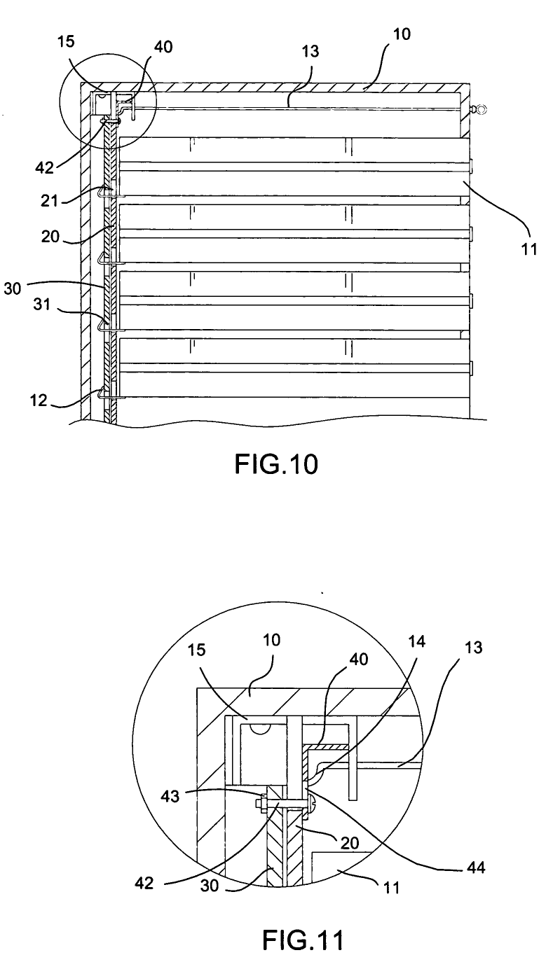

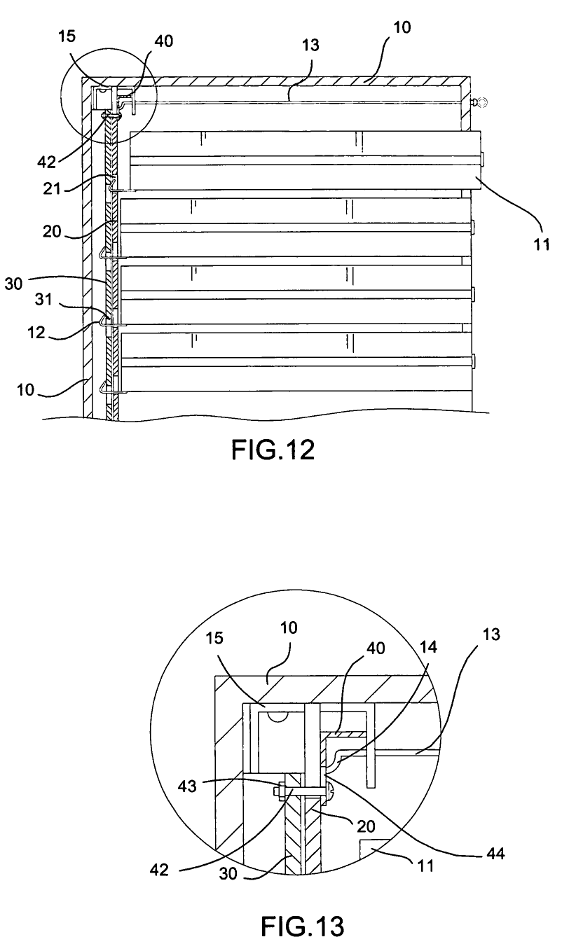

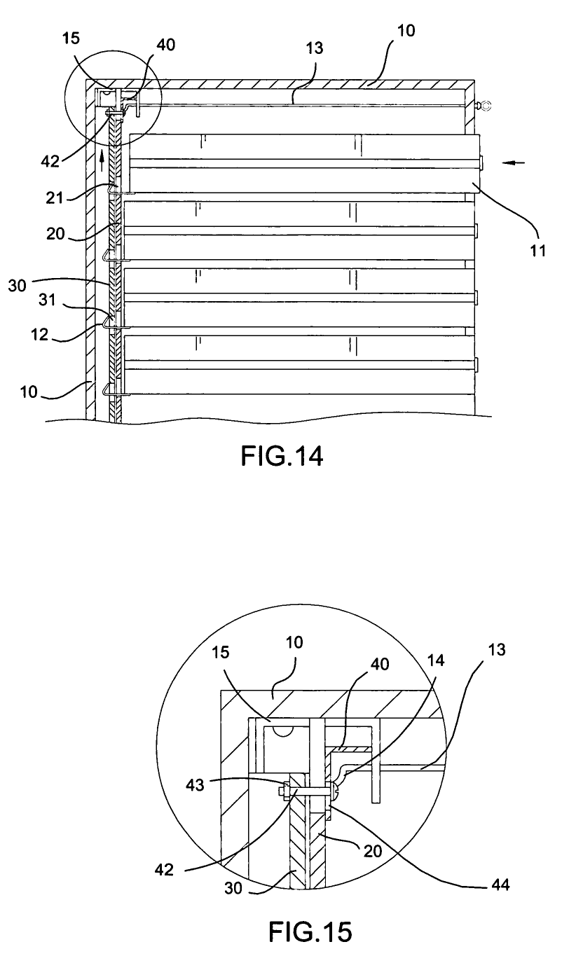

With reference to FIGS. 4-15, the shaft (13) is rotated to make hump (14) upwardly lift the shifting plate (40) with the second engaging plate (30). As a result, each second engaging hole (31) fully communicates with the corresponding one of the multiple first engaging holes (21) and the drawers are in an unlocked condition because the hook (12) of each of the multiple drawers (11) can be freely moved within the first engaging hole (21) and the second engaging hole (31).

The shaft (13) is rotated again to downward move the shifting plate (40) with the second engaging plate (30) after all the drawers (11) being fully pulled into the cabinet body (10) and the hook (12) of each of the drawers (11) extending through the first engaging hole (21) and the second engaging hole (31). As a result, the first engaging hole (21) and the second engaging hole (31) are interlaced relative to each other because the second engaging plate (30) is downward moved such that the hook (12) of each of the drawers (11) is engaged to the second engaging plate (30) and all the drawers are in a condition of being locked.

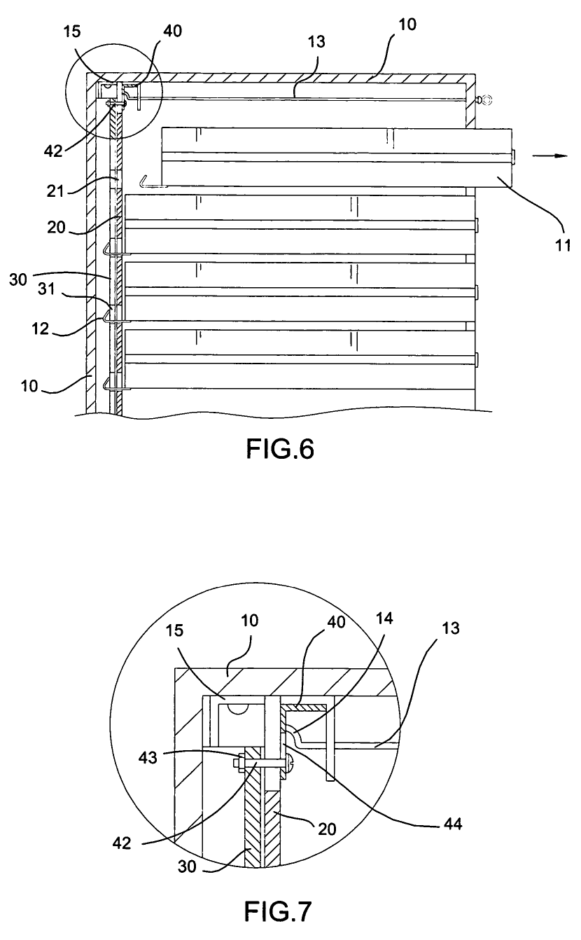

With reference to FIGS. 6, 12 and 14, the hook (12) of the unlocked drawer (11) upwardly pushed the second engaged plate (30) with the shifting plate (40) due to a height of the square hole (44) in the shifting plate (40). The second engaging plate (30) automatically downward moves to engage to the hook (12) and lock the unlocked drawer (11) due to a gravity of the second engaging plate (30) and the shifting plate (40). Consequently, the unlocked drawer(s) can be directly pulled into the cabinet body (10) and locked after the user finishing the lock operation without rotating the shaft (13) to unlock all the locked drawers (11). The locking assembly in accordance with the present invention provides a convenient operation when the user finds that one or some of the drawers (11) are not fully pushed into the cabinet body (10) and are not locked when finishing the locked operation.

Although the invention has been explained in relation to its preferred embodiment, it is to be understood that many other possible modifications and variations can be made without departing from the spirit and scope of the invention as hereinafter claimed.

What is claimed is:

1. A cabinet drawer locking assembly comprising:
a cabinet body and multiple drawers disposed in the cabinet body, each drawers having a hook backward extending therefrom
a shaft rotatably mounted on a top portion of the cabinet body, the shaft having a first end extending out of the cabinet body and connected with a lock unit that controls the shaft, and a second end extending through a bracket that is secured on a top of the cabinet body, the shaft having a hump formed within the bracket;
at least one first engaging plate vertically secured on a back of the cabinet body, and having multiple first engaging hole defined in and extending through the first engaging plate, the first engaging plate having an Ω-shaped cross-section such that a passage is formed between the back of the cabinet body and the first engaging plate, each first engaging hole corresponding to a hook of a corresponding one of the multiple drawers to allow the corresponding hook extend through the first engaging plate and entering the passage between the back of the cabinet body and the first engaging plate;
at least one second engaging plate slidably mounted between the first engaging plate and the back of the cabinet body and received in the passage between the back of the cabinet body and the first engaging plate, multiple second engaging holes defined in and extending through the second engaging plate, each second engaging hole selectively fully communicating with a corresponding one of the multiple first engaging hole to allow the corresponding hook extend through the first engaging plate; and
a shifting plate laterally extending through the bracket, a square hole defined in the shifting plate to allow the shaft extend through shifting plate and corresponding to the hump of the shaft, the shifting plate is connected to the top of the at least one second engaging plate such that the shifting plate is reciprocally up/down moved with the second engaging plate to unlock/lock the drawers when rotating the shaft.

2. The cabinet drawer locking assembly as claimed in claim 1, wherein the first engaging hole and the second engaging hole are interlaced relative to each other to make the second engaging plate engage to the hook of each of the drawers when the drawers are locked.

3. The cabinet drawer locking assembly as claimed in claim 1, wherein the shifting plate has at least one slot defined therein and corresponding to the through hole in the second engaging plate such that the second engaging plate are securely connected to the shifting plate when a screw extends through the through hole and the slot, and a nut is screwed onto the screw.
